(19) United States
(12) Patent Application Publication
(10) Pub. No.: US 2010/0174018 A1
(43) Pub. Date: Jul. 8, 2010

(54) AQUEOUS FORMULATIONS AND THE USE THEREOF FOR COLORING OR COATING SUBSTRATES

(75) Inventors: Holger Tuerk, Mannheim (DE); Karl Siemensmeyer, Frankenthal (DE); Oihana Elizalde, Mannheim (DE); Maria Teresa Hechavarria Fonseca, Buerstadt (DE); Karl Haeberle, Speyer (DE); Stefan Kuhn, Frankenthal (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/663,339

(22) PCT Filed: Jun. 23, 2008
(86) PCT No.: PCT/EP2008/057967

§ 371 Date: Dec. 7, 2009

(30) Foreign Application Priority Data
Jun. 29, 2007 (EP) 07111398.9
Sep. 17, 2007 (EP) 07116560.9

(51) Int. Cl. D06P 1/52; C09D 5/00

(52) U.S. Cl. 524/195; 524/507

(57) ABSTRACT

Aqueous formulations comprise
(A) at least one pigment,
(B) at least one carbodiimide,
(C) at least one random polyurethane, and
(D) optionally at least one polyacrylate comprising no interpolymerized comonomers capable of detaching one equivalent of formaldehyde per mole on exposure to temperatures in the range from 100 to 250° C.

The present invention provides aqueous formulations comprising
(A) at least one pigment,
(B) at least one carbodiimide,
(C) at least one random polyurethane, and
(D) optionally at least one polyacrylate comprising no interpolymerized comonomers capable of detaching one equivalent of formaldehyde per mole on exposure to temperatures in the range from 100 to 250° C.

The present invention further provides a process for producing the aqueous formulations of the present invention. The present invention further provides a process for coloring substrates by using the aqueous formulations of the present invention.

Colored substrates, in particular colored textile substrates, have to meet high requirements with regard to their general fastnesses. When substrates are colored with pigments, the lightfastnesses of the pigments used are generally good. It is less simple, however, to solve the problem of fixing pigments on the substrate so that they cannot be rubbed off the substrate in the wet or dry state. This applies particularly to polyester substrates and polypropylene substrates.

There has been no shortage of attempts to develop binders and fixers (crosslinkers) for pigment-containing systems that can ensure good general fastnesses and, in particular, good rubfastnesses. However, many such systems may release formaldehyde in certain amounts, which is extremely undesirable in the present age, either in the course of the processing or else even after prolonged use of the colored substrates thus obtained. In addition, such systems with good rubfastness tend to mark when scratched and present hand problems on polypropylene in particular.

WO 2004/031255 describes recording fluids useful for the ink jet process in particular and comprising random polyurethane copolymers and one or more melamine derivatives, the melamine derivative or derivatives serving as crosslinkers. However, it has emerged that some of the crosslinkers disclosed in WO 2004/031255 may release formaldehyde in small amounts, which is frequently undesirable.

The present invention has for its object to provide aqueous formulations and a process for their production which are useful for coloring substrates and which do not have the above-described disadvantages known from the prior art. The present invention further has for its object to provide a process for coloring substrates and the present invention has for its object to provide colored substrates which do not have the above-described disadvantages known from the prior art.

We have found that this object is achieved by the aqueous formulations defined at the beginning.

The aqueous formulations of the present invention comprise aqueous formulations. Aqueous formulations are formulations comprising solid material in dispersed or dissolved form and a continuous phase, the continuous phase consisting mainly, i.e., to more than 50% by volume, of water. Formulations of the present invention may comprise one or more organic solvents or alternatively be free of organic solvents.

Aqueous formulations of the present invention comprise

(A) at least one pigment.

Pigment (A) herein refers to substantially insoluble, dispersed, finely divided, organic or inorganic colorants as per the definition in German standard specification DIN 55944.

Examples of preferred pigments (A) are:

monoazo pigments, for example C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C.I. Pigment Yellow 1, 3, 73, 74, 65, 97, 151 and 183;

disazo pigments, for example C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188;

anthanthrone pigments, for example C.I. Pigment Red 168 (C.I. Vat Orange 3);

anthraquinone pigments, for example C.I. Pigment Yellow 147 and 177; C.I. Pigment Violet 31;

anthrapyrimidine pigments, for example C.I. Pigment Yellow 108 (CI Vat Yellow 20);

quinacridone pigments, for example C.I. Pigment Red 122, 202 and 206; C.I. Pigment Violet 19;

quinophthalone pigments, for example C.I. Pigment Yellow 138;

dioxazine pigments, for example C.I. Pigment Violet 23 and 37;

flavanthrone pigments, for example C.I. Pigment Yellow 24 (C.I. Vat Yellow 1); indanthrone pigments, for example C.I. Pigment Blue 60 (C.I. Vat Blue 4) and 64 (C.I. Vat Blue 6);

isoindoline pigments, for example C.I. Pigment Orange 69; C.I. Pigment Red 260; C.I. Pigment Yellow 139 and 185;

isoindolinone pigments, for example C.I. Pigment Orange 61; C.I. Pigment Red 257 and 260; C.I. Pigment Yellow 109, 110, 173 and 185;

isoviolanthrone pigments, for example C.I. Pigment Violet 31 (C.I. Vat Violet 1);

metal complex pigments, for example C.I. Pigment Yellow 117, 150 and 153; C.I. Pigment Green 8;

perinone pigments, for example C.I. Pigment Orange 43 (C.I. Vat Orange 7); C.I. Pigment Red 194 (C.I. Vat Red 15);

perylene pigments, for example C.I. Pigment Black 31 and 32; C.I. Pigment Red 123, 149, 178, 179 (C.I. Vat Red 23), 190 (C.I. Vat Red 29) and 224; C.I. Pigment Violet 29;

phthalocyanine pigments, for example C.I. Pigment Blue 15, 15:1, 15:2, 15:3, 15:4, 15:6 and 16; C.I. Pigment Green 7 and 36;

pyranthrone pigments, for example C.I. Pigment Orange 51; C.I. Pigment Red 216 (C.I. Vat Orange 4);

thioindigo pigments, for example C.I. Pigment Red 88 and 181 (C.I. Vat Red 1); C.I. Pigment Violet 38 (C.I. Vat Violet 3);

triarylcarbonium pigments, for example C.I. Pigment Blue 1, 61 and 62; C.I. Pigment Green 1; C.I. Pigment Red 81, 81:1 and 169; C.I. Pigment Violet 1, 2, 3 and 27;

C.I. Pigment Black 1 (Aniline Black);

C.I. Pigment Yellow 101 (Aldazine Yellow); C.I. Pigment Brown 22.

Examples of particularly preferred pigments are specifically: C.I. Pigment Yellow 138, C.I. Pigment Red 122, C.I. Pigment Violet 19, C.I. Pigment Blue 15:3 and 15:4, C.I. Pigment Black 7, Ci. Pigment Orange 5, 38 and 43 and C.I. Pigment Green 7.

The average diameter of pigment (A) can be in the range from 20 nm to 1.5 μm, and preferably in the range from 300 to 500 nm.

In one embodiment of the present invention, pigment (A) is present in spherical or substantially spherical particulate form; that is, the ratio of the longest diameter to the smallest diameter is in the range from 1.0 to 2.0 and preferably up to 1.5.

Pigment (A) is preferably included in the aqueous formulation of the present invention in the form of pigment preparations. Pigment preparations comprise typically 20% to 60% by weight of pigment (A), water and one or more surface-active compounds, for example one or more surfactants (E), which are described herein below.

Aqueous formulation of the present invention further comprises at least one carbodiimide (B).

Carbodiimide (B) may for example have the formula I

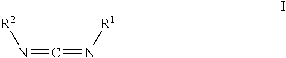

where R¹ and R² may be the same or different and are each selected from
C₁-C₂₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, n-dodecyl, isododecyl, n-tetradecyl, n-hexadecyl, n-octadecyl, n-eicosyl; preferably C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; more preferably C₁-C₄-alkyl such as methyl, ethyl, n-propyl, isopropyl, n-butyl, isobutyl, sec-butyl and tert-butyl;
C₃-C₂₀-cycloalkyl, monocyclic or bicyclic, unsubstituted or substituted with for example C₁-C₆-alkyl or with isocyanate, such as cyclopropyl, cyclobutyl, cyclopentyl, cyclohexyl, cycloheptyl, cyclooctyl, 2,5-dimethylcyclopentyl, 2,6-dimethyl-cyclohexyl, methyl-C₅-C₇-cycloalkyl, isocyanatocyclohexyl, methyl-[isocyanato-C₅-C₇-cycloalkyl],
C₆-C₁₄-aryl, unsubstituted or substituted one or more times with for example C₁-C₆-alkyl or with isocyanate or with isocyanato-C₁-C₆-alkyl, in particular with C(CH₃)₂—NCO, for example —C₆H₃(CH₃)NCO, —C₆H₄—NCO, C₇-C₁₅-alkylaryl, particularly —C(CH₃)₂—C₆H₄—C(CH₃)₂—NCO, meta or para, methyl-C₅-C₇-cycloalkyl, unsubstituted or substituted with isocyanate or with isocyanato-C₁-C₆-alkyl, in particular with C(CH₃)₂—NCO,
isophoryl,
C₃-C₆-hetaryl, for example imidazolyl.

Carbodiimide (B) preferably comprises a polymeric carbodiimide. Polymeric carbodiimides for the purposes of the present invention are such compounds as bear from 2 to 50, and preferably up to 20 —N═C═N— groups per mole.

Polymeric carbodiimides are known per se and are obtainable by methods known per se, for example by condensation or polycondensation of diisocyanate in the presence of a catalyst, for example trialkyl phosphine oxide, acyclic or preferably cyclic, phospholene oxide, triaryl phosphine oxide, alkali metal alkoxide, for example sodium ethoxide, alkali metal carbonate, for example sodium carbonate or potassium carbonate, or tertiary amine, for example triethylamine. Particularly suitable catalysts are phospholane oxides and phospholene oxides, examples being 1-phenyl-2-methyl 2-phospholene oxide, 1-phenyl-2-methyl 3-phospholene oxide, 1-methyl 2-phospholene oxide and 1-methyl 3-phospholene oxide, see for example US 2,853,473. Carbon dioxide is eliminated in the course of the condensation or polycondensation to form polymeric carbodiimide.

Examples of polymeric carbodiimides are obtainable by condensation or polycondensation of at least one aromatic diisocyanate, for example 2,4-tolylene diisocyanate, 4,4′-diphenylmethane diisocyanate or 1,7-naphthylene diisocyanate or at least one aliphatic or cycloaliphatic carbodiimide such as for example isophorone diisocyanate, trimethylene diisocyanate, tetramethylene diisocyanate, hexamethylene diisocyanate, dodecamethylene diisocyanate, cyclohexane 1,4-diisocyanate, 2,4-hexahydrotolylene diisocyanate, 2,6-hexahydrotolylene diisocyanate and 4,4′-dicyclohexylmethane diisocyanate.

Preferred polymeric carbodiimides are copolycarbodiimides obtainable by condensation or polycondensation of at least one aromatic diisocyanate, for example 2,4-tolylene diisocyanate, 4,4′-diphenylmethane diisocyanate or 1,7-naphthylene diisocyanate, with at least one aliphatic or cycloaliphatic carbodiimide such as for example isophorone diisocyanate, trimethylene diisocyanate, tetramethylene diisocyanate, hexamethylene diisocyanate, dodecamethylene diisocyanate, cyclohexane 1,4-diisocyanate, 2,4-hexahydrotolylene diisocyanate, 2,6-hexahydro-tolylene diisocyanate and 4,4′-dicyclohexylmethane diisocyanate.

It is very particularly preferred for carbodiimide (B) to comprise a polymeric carbodiimide obtainable by polycondensation of m-TMXDI or p-TMXDI

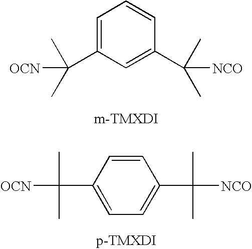

or mixtures of m-TMXDI and p-TMXDI having 2 to 20, preferably up to 15 and more preferably up to 10 —N═C═N— groups per mole.

Aqueous formulations of the present invention further comprise

(C) at least one random polyurethane,

herein also referred to as polyurethane (C).

By random polyurethanes (C) are meant not just polyaddition products linked together by urethane groups only, but in a more general sense polymers obtainable by reaction of di- or polyisocyanates with compounds comprising active hydrogen atoms.

As well as urethane groups, polyurethanes (C) may thus also comprise one or more urea, allophanate, biuret, carbodiimide, amide, ester, ether, uretonimine, uretidione, isocyanurate or oxazolidine groups per molecule. An overview may be had for example from: Kunststoffhandbuch/Saechtling, 26th edition, Carl-Hanser-Verlag, Munich 1995, pages 491 ff. More particularly, polyurethanes (C) may comprise one or more urea groups per molecule. However, polyurethanes (C) comprise at least one urethane group per molecule.

Random polyurethane (C) is obtained from at least one diisocyanate and at least two compounds having two or more isocyanate-reactive groups.

The diisocyanate or diisocyanates may have NCO groups of the same or different reactivities. Examples of diisocyanates having NCO groups of the same reactivity are aromatic or aliphatic diisocyanates, preference being given to aliphatic diisocyanates such as tetramethylene diisocyanate, hexamethylene diisocyanate, octamethylene diisocyanate, decamethylene diisocyanate, dodecamethylene diisocyanate, tetra-decamethylene diisocyanate, trimethylhexane diisocyanate, tetramethylhexane diisocyanate, 1,4-, 1,3- or 1,2-diisocyanatocyclohexane, 4,4′-di(isocyanatocyclohexyl)methane, 1-isocyanato-3,3,5-trimethyl-5-(isocyanatomethyl)cyclohexane (isophorone diisocyanate) and 2,4- and 2,6-di-isocyanato-1-methylcyclohexane, of which hexamethylene diisocyanate and isophorone diisocyanate are particularly preferred. m-Tetramethylxylylene diisocyanate (TMXDI) is another particularly preferred diisocyanate.

Preferred diisocyanates having NCO groups of different reactivities are readily and inexpensively available isocyanates such as for example 2,4-tolylene diisocyanate (2,4-TDI), 2,4′-diphenylmethane diisocyanate (2,4′-MDI), triisocyanatotoluene as a representative of aromatic diisocyanates or aliphatic diisocyanates, such as 2-butyl-2-ethylpentamethylene diisocyanate, 2-isocyanatopropylcyclohexyl isocyanate, 2,4,4- and 2,2,4-trimethylhexamethylene diisocyanate, 2,4′-methylenebis(cyclohexyl)diisocyanate and 4-methylcyclohexane 1,3-diisocyanate (H-TDI).

Further examples of diisocyanates having groups of different reactivities are 1,3-phenylene diisocyanate, 1,4-phenylene diisocyanate, 1,5-naphthylene diisocyanate, biphenyl diisocyanate, tolidine diisocyanate and 2,6-tolylene diisocyanate.

Particular preference is given to aliphatic and cycloaliphatic diisocyanates such as for example hexamethylene diisocyanate (HDI) and isophorone diisocyanate.

It will be appreciated that mixtures of at least two of the aforementioned isocyanates can be used as well.

It is also possible to replace portions of the diisocyanate by polyisocyanates, for example triisocyanate or tetraisocyanate, in order that branching may be incorporated in the polyurethane block.

Random polyurethane (C) is further prepared using at least two compounds having two or more isocyanate-reactive groups. These compounds are incorporated in polyurethane (C), herein also referred to as “interpolymerized”.

By “random” is meant that no blocklike structures are produced.

Examples of compounds bearing two or more isocyanate-reactive groups such as for example OH, SH, NH₂ or NHR⁴, where R⁴ is selected from C₁-C₁₂-alkyl, are for example diols and secondary diamines. Examples are secondary diamines, for example 1,4-butylene-N,N′-dimethylamine, and preferably linear or branched aliphatic diols (c1). Particular preference is given to aliphatic diols having 2 to 10 carbon atoms (c1). Candidates include in particular: ethylene glycol, 1,2-propanediol, 1,3-propanediol, 1,4-butanediol, 1,6-hexanediol, neopentylglycol, cis-1,2-cyclohexane-dimethanol, trans-1,2-cyclohexanedimethanol and also cis- and trans-1,4-cyclohexane-dimethanol. It is also possible to use mixtures of the aforementioned aliphatic diols having 2 to 10 carbon atoms (c1).

Polyetherpolyols are examples of particularly useful aliphatic diols (c1). Polyetherpolyols herein are reaction products of dihydric or higher alkyls such as for example ethylene glycol, propylene glycol or glycerol with one or more equivalents of C₂-C₄-alkylene oxide, for example butylene oxide and preferably propylene oxide and/or ethylene oxide. To prepare ethylene oxide-propylene oxide intercondensation products, the reaction may preferably be controlled such as to obtain products having overwhelmingly primary hydroxyl groups in the terminal positions.

The molecular weight Mₙ of useful polyether polyols is preferably in the range from 250 to 4000 g/mol and particularly in the range from 400 to 2500 g/mol.

Further useful compounds comprise at least 2 different isocyanate-reactive groups, for example thioglycol or ethanolamine or methyldiethanolamine.

Polyesterols (c2) are further useful compounds having at least two isocyanate-reactive groups. Polyesterols for the purposes of the present invention have two or more hydroxyl groups.

Polyesterols (c2) are obtainable by polycondensation of at least one aliphatic diol with at least one aliphatic or aromatic dicarboxylic acid. Small proportions of aliphatic diol, for example up to 10 mol %, may be replaced by aliphatic triol or tetraol such as for example glycerol, 1,1,1-trimethylolethane, 1,1,1-trimethylolpropane, 1,1,1-trimethylol-butane or pentaerythritol. Similarly, smaller proportions of aromatic or aliphatic dicarboxylic acid, for example up to 10 mol %, may be replaced by tri- or tetracarboxylic acid, for example hemimellitic acid (1,2,3-benzenetricarboxylic acid), trimellitic acid (1,2,4-benzenetricarboxylic acid), trimesic acid (1,3,5-benzenetricarboxylic acid) or pyromellitic acid (1,2,4,5-benzenetetracarboxylic acid).

Examples of useful aliphatic diols are aliphatic or cycloaliphatic diols, preferably having two to 20 carbon atoms per molecule and more preferably having two to 12 carbon atoms per molecule. Examples of aliphatic diols are in particular ethylene glycol, diethylene glycol, triethylene glycol, tetraethylene glycol, 1,2-propanediol (propylene glycol), dipropylene gycol, 1,3-propanediol, 1,4-butanediol, 1,6-hexanediol, 1,10-decanediol, 1,12-dodecanediol, neopentylglycol, cis-1,2-cyclohexanedimethanol, trans-1,2-cyclohexanedimethanol and also cis- or trans-1,4-cyclohexanedimethanol.

Examples of useful aliphatic dicarboxylic acids are C₂-C₁₀-dicarboxylic acids, examples being oxalic acid, malonic acid, succinic acid, glutaric acid, adipic acid, sebacic acid, pimellic acid, hexahydrophthalic acid and hexahydroisophthalic acid.

Examples of useful aromatic dicarboxylic acids are naphthalene-1,5-dicarboxylic acid, naphthalene-2,6-dicarboxylic acid, terephthalic acid, phthalic acid and particularly isophthalic acid.

It will be appreciated that mixtures of two or more aliphatic dicarboxylic acids, in particular mixtures of succinic acid, glutaric acid and adipic acid, can also be used for the synthesis of polyester polyol (c2).

One version of the present invention synthesizes polyesterpolyol (c2) by using a mixture of at least one aliphatic and at least one aromatic dicarboxylic acid, preference being given to mixtures of phthalic acid or particularly isophthalic acid with ethylene glycol, 1,2-propanediol, 1,3-propanediol, 1,4-butanediol, 1,6-hexanediol, cis- or trans-1,2-cyclohexanedimethanol and also cis- or trans-1,4-cyclohexanedimethanol.

One version of the present invention utilizes aromatic or aliphatic dicarboxylic anhydride, for example succinic anhydride or phthalic anhydride, instead of the corresponding acid.

In one embodiment of the present invention, polyesterpolyol (c2) has an average molecular weight Mₙ in the range from 250 to 10 000 g/mol, preferably up to 4000 g/mol and more preferably in the range from 400 to 2500 g/mol.

The preparation of polyesterol (c2) is known per se and is accomplished by esterifying one or more aliphatic or aromatic dicarboxylic acids or anhydrides with one or more aliphatic diols, if appropriate together with small proportions of triol, tetraol, tricarboxylic acid or tetracarboxylic acid. The preparation of polyesterol (c2) can also be accomplished by transesterification of one or more aliphatic or aromatic dimethyl or diethyl dicarboxylates with one or more aliphatic diols, if appropriate together with small proportions of triol, tetraol, tricarboxylic acid or tetracarboxylic acid.

The esterification or transesterification can be carried out in solution or without a solvent. It is preferably carried out in the presence of a catalyst, particularly an acidic catalyst, examples being sulfuric acid, organic sulfonic acid, acidic silica gels, acidic alumina and acidic ion exchangers. Similarly, the use of an entrainer to distill off azeotropic entrainer-water mixtures is suitable.

Examples of useful aliphatic diols (c1) further include polycaprolactonediols and polycaprolactonetriols.

In one embodiment of the present invention, random polyurethane (C) comprises a polyurethane further comprising
(c3) an interpolymerized compound having at least one carboxylic acid group or at least one sulfonic acid group per molecule, also referred to as compound (c3) for short.

Examples of compounds (c3) are diamines, amino alcohols and particularly diols having at least one carboxylic acid group or at least one sulfonic acid group per molecule. Specific examples are 2,2-bis(hydroxymethyl)propionic acid, bis(hydroxymethyl)acetic acid and 2,2-bis(hydroxymethyl)butyric acid, and also

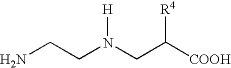

where R⁴ may be methyl or preferably hydrogen, and

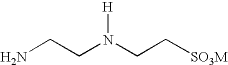

where M is selected from hydrogen, alkali metal ions and ammonium ions, substituted or unsubstituted.

In one embodiment of the present invention, the molar ratio of (c1) to (c2) is in the range from 1:2 to 2:1; most preferably, the molar ratio of (c1) to (c2) is 1:1.

In one embodiment of the present invention, the molar ratio of (c1) or (c2) to (c3) is in the range from 1:2 to 2:1.

Polyurethane (C) may be prepared using one or more catalysts. Useful catalysts, which speed particularly the reaction between the NCO groups of the diisocyanates and the hydroxyl groups and amino groups of the compounds bearing two isocyanate-reactive groups, are the customary tertiary amines known in the prior art, examples being triethylamine, dimethylcyclohexylamine, N-methylmorpholine, N,N′-dimethylpiperazine, 2-(dimethylaminoethoxy)ethanol, diazabicyclo-(2,2,2)-octane and the like, and also, in particular, organic metal compounds such as titanic esters, iron compounds such as, for example, iron(III) acetylacetonate, zinc compounds or bismuth compounds, examples being salts of zinc or of bismuth with aliphatic carboxylic acids, in particular acetic acid or fatty acids such as for example stearic acid, tin compounds, for example tin acetate, tin dioctoate, tin dilaurate or the dialkyl derivatives of tin dialkyl salts of aliphatic carboxylic acids such as di-n-butyltin diacetate, di-n-butyltin dilaurate or the like. The catalyst or catalysts are typically used in amounts of 0.0001 to 0.1 part by weight per 100 parts by weight of diisocyanate.

One embodiment of the present invention comprises neutralizing strongly acidic groups of random polyurethane (C) such as for example free carboxylic acid groups or sulfonic acid groups with base such as for example alkali metal hydroxide. The neutralizing is preferably effected with volatile base such as for example primary, secondary or tertiary amine, examples being methylamine, dimethylamine, trimethylamine, ethylamine, diethylamine, triethylamine, isopropylamine, ethyldiisopropylamine, di-n-butylamine, ethanolamine, diethanolamine, triethanolamine, N-methyldiethanolamine, n-propyldiethanolamine, n-butyldiethanolamine or N,N-dimethylethanolamine. It is particularly preferred to effect the neutralizing with ammonia.

Aqueous formulation of the present invention may optionally further comprise (D) at least one polyacrylate comprising no interpolymerized comonomers capable of detaching one equivalent of formaldehyde per mole on exposure to temperatures in the range from 100 to 250° C., herein also referred to as polyacrylate (D) for short.

Polyacrylate (D) comprises or concerns no binders comprising interpolymerized comonomers, comprising interpolymerized N-methylol(meth)acrylamide for example. Polyacrylate (D) further comprises or concerns no N-methylolurea derivatives.

Aqueous formulation used in the process of the present invention thus typically comprises no binder comprising interpolymerized comonomer capable of detaching one equivalent of formaldehyde per mole on exposure to temperatures in the range from 100 to 250° C. or below.

Polyacrylate (D) herein refers to addition copolymers obtained by preferably free-radical copolymerization of at least two comonomers of which at least one is selected from (meth)acrylic acid and (meth)acrylates, for example C₁-C₂₀-alkyl(meth)acrylates, preferably C₁-C₁₀-alkyl(meth)acrylates, and which preferably comprise at least 50% by weight of polyacrylate (D).

One embodiment of the present invention selects polyacrylate (D) from copolymers comprising interpolymerized (meth)acrylic acid, an interpolymerized comonomer having an epoxy group in the molecule such as for example glycidyl(meth)acrylate, interpolymerized ω-C₂-C₁₀-hydroxyalkyl(meth)acrylate or an interpolymerized (meth)acrylic ester of an alcohol of the general formula I

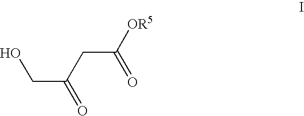

where
R⁵ is selected from branched and preferably unbranched C₁-C₁₀-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, or more preferably unbranched C₁-C₄-alkyl such as methyl, ethyl, n-propyl and n-butyl.

Useful poly(meth)acrylates for the purposes of the present invention include copolymers of one or more C₁-C₁₀-alkyl esters of (meth)acrylic acid with, for example, (meth)acrylic acid, glycidyl (meth)acrylate or C₂-C₁₀-hydroxyalkyl(meth)acrylate and if appropriate one or more further interpolymerized comonomers. Useful further comonomers include for example aromatic vinyl compounds such as α-methyl styrene, para-methylstyrene and particularly styrene, also (meth)acrylamide, vinyl chloride, (meth)acrylonitrile.

Examples of particularly suitable C₁-C₁₀-alkyl esters of (meth)acrylic acid are methyl(meth)acrylate, ethyl(meth)acrylate, n-propyl(meth)acrylate, isopropyl(meth)acrylate, n-butyl(meth)acrylate, n-hexyl(meth)acrylate, 2-ethylhexyl(meth)acrylate, n-decyl(meth)acrylate.

Examples of particularly suitable w-hydroxy-C₂-C₁₀-alkylene esters of (meth)acrylic acid are in particular w-hydroxy-C₂-C₁₀-alkyl(meth)acrylates such as 6-hydroxyhexyl(meth)-acrylate, 4-hydroxybutyl(meth)acrylate, 3-hydroxypropyl(meth)acrylate and particularly 2-hydroxyethyl(meth)acrylate.

A preferred version selects polyacrylate (D) from such poly(meth)acrylates as comprise copolymers of one or more C₁-C₁₀-alkyl esters of (meth)acrylic acid and (meth)acrylic acid and at least one comonomer selected from glycidyl(meth)acrylate and C₂-C₁₀-hydroxyalkyl(meth)acrylate in interpolymerized form plus, if appropriate, one or more further comonomers.

Polyacrylate (D) may have a molecular weight Mₙ in the range from 5000 to 1 000 000 g/mol.

Polyacrylate (D) is preferably obtainable by free-radical (co)polymerization of the appropriate comonomers, preferably by free-radical emulsion copolymerization, herein also referred to simply as free-radical emulsion polymerization.

To use in aqueous formulation used according to the present invention a polyacrylate (D) comprising interpolymerized (meth)acrylic acid, the carboxyl groups of the interpolymerized (meth)acrylic acid can be present in free form or in completely or partially neutralized form, for example completely or partially neutralized with alkali, with ammonia or with amine. Particularly useful amines include for example tertiary amines, for example (C₁-C₄-alkyl)₃N, in particular triethylamine, and alkanolamines such as for example ethanolamine, diethanolamine, triethanolamine, N-methyl-ethanolamine, N,N-dimethylethanolamine and N-(n-butyl)ethanolamine. Very particular preference, however, is given to using polyacrylate (D) partially or completely neutralized with ammonia.

Polyacrylate (D) is preferably generated in the form of spherical particles dispersed in water. The spherical particles may have for example an average diameter in the range from 10 nm to 10 μm, preferably 20 nm to 1 μm.

In one embodiment of the present invention, aqueous formulations of the present invention comprise at least one surfactant (E), which may be cationic, anionic or preferably nonionic.

Examples of cationic surfactants (E) are multiply C₂-C₄-alkoxylated aliphatic di-, tri- and tetramines, in particular 5- to 50-tuply ethoxylated ethylenediamine, diethylenetriamine and triethylenetetramine. Such cationic surfactants (E) are particularly effective to combine with pigment (A) in a pigment preparation.

Examples of useful anionic surfactants (E) are, for example, alkali metal and ammonium salts of alkyl sulfates (alkyl radical: C₈ to C₁₂), of acid sulfuric esters of ethoxylated alkanols (degree of ethoxylation: 3 to 30, alkyl radical: C₁₀-C₂₀, preferably C₁₂-C₁₈) and of ethoxylated alkylphenols (degree of ethoxylation: 3 to 50, alkyl radical: C₄-C₁₂), of alkylsulfonic acids (alkyl radical: C₁₂-C₁₈) and of alkylarylsulfonic acids (alkyl radical: C₉-C₁₈).

Examples of nonionic surfactants (E) are, for example, ethoxylated mono-, di- and trialkyl phenols (degree of ethoxylation: 3 to 50, alkyl radical: C₄-C₁₂) and also ethoxylated fatty alcohols (degree of ethoxylation: 3 to 80; alkyl radical: C₈-C₃₆). Examples are the Lutensol® brands from BASF Aktiengesellschaft.

Examples of preferred nonionic surfactants (E) are singly or multiply alkoxylated, preferably propoxylated and particularly multiply, for example 3- to 100-tuply, ethoxylated fatty alcohols, oxo process alcohols and particularly aryl polyglycol ethers, for example of the formula Ill a to III c:

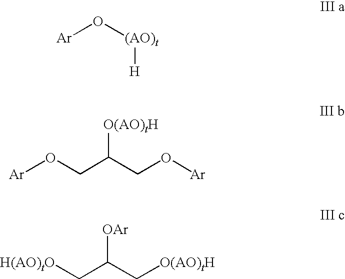

where
Ar: in each occurrence is different or, if appropriate, the same, C₆-C₁₄-aryl, for example phenyl, naphthyl or phenanthryl, unsubstituted or substituted one or more times, in particular with C₁-C₄-alkyl, branched or unbranched, for example methyl, ethyl, n-propyl, isopropyl, n-butyl, isobutyl, or with alkylaryl, for example styryl; preferred substituted phenyl radicals are each substituted with C₁-C₄-alkyl in position 2,6 or in position 2,4,6.
t in each occurrence is different or preferably the same and selected from numbers in the range from 1 to 100, preferably 2 to 50 and more preferably 3 to 20.

Aqueous formulations of the present invention may further comprise one or more auxiliary components (F).

Auxiliary components (F) include for example thickeners (thickening agents), solvents, defoamers, wetting agents, hand improvers, dispersants, water-retaining agents, antisettling agents and/or biocides. Thickeners and defoamers are preferred auxiliary components.

Aqueous formulations in accordance with the present invention may comprise for example one or more natural thickeners or preferably one or more synthetic thickeners. Natural thickeners are such thickeners as are natural products or as are obtainable by workup such as for example purifying operations, in particular extraction of natural products. Examples of inorganic natural thickeners are sheet silicates such as bentonite for example. Examples of organic natural thickeners are preferably proteins such as for example casein or preferably polysaccharides. Particularly preferred natural thickeners are selected from agar, carrageenan, gum arabic, alginates such as for example sodium alginate, potassium alginate, ammonium alginate, calcium alginate and propylene glycol alginate, pectins, polyoses, carob bean gum (Carubin) and dextrins.

Preference is given to using synthetic thickeners selected from generally liquid solutions, emulsions or dispersions of synthetic polymers, particularly acrylates, in for example white oil or as aqueous solutions. Synthetic polymers used as thickeners comprise acid groups, which are neutralized with ammonia completely or to a certain percentage. In the course of the fixing operation, ammonia is released, reducing the pH and starting the actual fixing. The pH reduction necessary for fixing may alternatively be effected by adding nonvolatile acids such as for example citric acid, succinic acid, glutaric acid or malic acid. Similarly, diammonium phosphate and sodium diammonium phosphate are useful for lowering the pH.

Very particularly preferred synthetic thickeners are selected from copolymers of 85% to 99.9% by weight of acrylic acid, 0% to 14% by weight of acrylamide and 0.01% to not more than 1% by weight of the (meth)acrylamide derivative of the formula IV

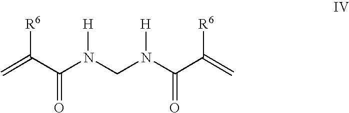

having molecular weights M_{w} in the range from 100 000 to 2 000 000 g/mol, in each of which the R⁶ radicals may be the same or different and may each represent methyl or hydrogen.

Aqueous formulations of the present invention may comprise one or more solvents, which in the context of the present invention is to be understood as referring to organic solvents such as for example methanol, ethanol or isopropanol.

Aqueous formulations of the present invention may comprise one or more defoamers. Suitable defoamers are for example siliconic defoamers such as for example those of the formula HO—(CH₂)₃—Si(CH₃)[OSi(CH₃)₃]₂ and HO—(CH₂)₃—Si(CH₃)[OSi(CH₃)₃][OSi(CH₃)₂OSi(CH₃)₃], nonalkoxylated or alkoxylated with up to 20 equivalents of alkylene oxide and particularly ethylene oxide. Silicone-free defoamers are also suitable, examples being multiply alkoxylated alcohols, for example fatty alcohol alkoxylates, preferably 2 to 50-tuply ethoxylated preferably unbranched C₁₀-C₂₀-alkanols, unbranched C₁₀-C₂₀-alkanols and 2-ethylhexan-1-ol. Further suitable defoamers are fatty acid C₈-C₂₀-alkyl esters, preferably C₁₀-C₂₀-alkyl stearates, in each of which C₈-C₂₀-alkyl and preferably C₁₀-C₂₀-alkyl may be branched or unbranched. Further suitable defoamers are trialkyl phosphates such as triisobutyl phosphate for example.

Aqueous formulations of the present invention may comprise for example one or more wetting agents, preferably low-sudsing wetting agents, since sudsing can impair the quality of the treatment through formation of unlevelnesses. Wetting agents used include for example: ethoxylation and/or propoxylation products of fatty alcohols or propylene oxide-ethylene oxide block copolymers, ethoxylated or propoxylated fatty or oxo process alcohols, also ethoxylates of oleic acid or alkylphenols, alkylphenol ether sulfates, alkylpolyglycosides, alkyl phosphonates, alkylphenyl phosphonates, alkyl phosphates or alkylphenyl phosphates.

Aqueous formulations of the present invention may further comprise one or more hand improvers, typically selected from silicones, in particular polydimethylsiloxanes, and fatty acid esters.

Aqueous formulations of the present invention may comprise one or more dispersants. Examples of suitable dispersants are aryl- or alkyl-substituted polyglycol ethers, also substances described in U.S. Pat. No. 4,218,218 and homologs where y (from the formulae of U.S. Pat. No. 4,218,218) is in the range from 10 to 37.

Aqueous formulations of the present invention may comprise one or more water-retaining agents. Urea is an example of a suitable water-retaining agent.

Aqueous formulations of the present invention may comprise one or more biocides. Suitable biocides are for example commercially available as Proxel brands. Examples which may be mentioned are: 1,2-benzisothiazolin-3-one (“BIT”) (commercially available as Proxel® brands from Avecia Lim.) and its alkali metal salts; other suitable biocides are 2-methyl-2H-isothiazole-3 (“MIT”) and 5-chloro-2-methyl-2H-isothiazol-3-one (“CIT”).

Examples of suitable antisettling agents are silicates and silica gels, for example with an average particle diameter (in particular secondary particle diameter) in the range from 10 to 500 nm, particularly fumed silica gels. Suitable fumed silica gels are commercially available as Aerosil® brands for example.

Aqueous formulations of the present invention may comprise one or more foaming agents as auxiliary component (F), in particular if they are to be used for coating, examples of foaming agents being ammonium salts of fatty acids, preferably ammonium stearate.

It is possible for one auxiliary component (F) to perform more than one function. For example, multiply ethoxylated fatty alcohols such as for example n-C₁₈H₃₇O(CH₂CH₂O)₁₅H can simultaneously act as a wetting agent, as an emulsifier and as a low-sudsing dispersant.

In one embodiment of the present invention, aqueous formulation of the present invention comprises

0.05% to 10% by weight and preferably 0.5% to 3% by weight of pigment (A),

0.1% to 15% by weight and preferably 0.2% to 6% by weight of carbodiimide (B),

0.1% to 20% by weight and preferably 2.5% to 10% by weight of random polyurethane (C),

zero to 25% by weight and preferably 0.5% to 20% by weight of polyacrylate (D),

zero to 5% by weight and preferably 0.1% to 1% by weight of surfactant (E),

zero to altogether 10% by weight and preferably 0.1% to 5% by weight of auxiliary component(s) (F).

These weight % ages are each based on total aqueous formulation of the present invention.

In one embodiment of the present invention, aqueous formulations of the present invention comprise 1% to 15% by weight, preferably 1.5% to 10% by weight and more preferably 2% to 5% by weight of polyacrylate (D). This embodiment is preferred when aqueous formulation of the present invention is to be embodied as a print paste for a process for printing substrates.

In another embodiment of the present invention, aqueous formulations of the present invention comprise 10% to 25% by weight and preferably 12% to 20% by weight of polyacrylate (D). This embodiment is preferred when aqueous formulation of the present invention is to be used for a process for coating substrates.

In another embodiment of the present invention, aqueous formulations of the present invention comprise 0.5% to 15% by weight and preferably up to 5% by weight of polyacrylate (D). This embodiment is preferred when aqueous formulation of the present invention is to be embodied as a liquor for a process for dyeing substrates or as an ink for printing by the ink jet process.

There are many embodiments of the present invention where it is preferable that aqueous formulations of the present invention comprise at least one polyacrylate (D). However, in those embodiments where substrates composed of polyester are to be colored it is preferable that aqueous formulations of the present invention comprise no polyacrylate (D).

Aqueous formulations of the present invention further comprise water.

In one embodiment of the present invention, aqueous formulations of the present invention are selected from aqueous print pastes, dyeing liquors, coating pastes and pastes for fibrous nonwoven web consolidation.

In one embodiment of the present invention, aqueous formulations of the present invention have a water content in the range from 60% to 95% by weight and preferably in the range from 80% to 95% by weight. This embodiment is preferred when aqueous formulation of the present invention is to be embodied as a print paste for printing substrates.

In one embodiment of the present invention, aqueous formulations of the present invention have a water content in the range from 20% to 80% by weight and preferably to 70% by weight. This embodiment is preferred when aqueous formulation of the present invention is to be embodied for a process for coating substrates.

In one embodiment of the present invention, aqueous formulations of the present invention have a water content in the range from 90% to 98% by weight. This embodiment is preferred when aqueous formulation of the present invention is to be embodied as a liquor for a process for dyeing substrates.

In one embodiment of the present invention, aqueous formulation of the present invention has a pH in the range from 7 to 9 and preferably in the range from 7 to 8.5.

In one embodiment of the present invention, aqueous formulation of the present invention has a solids content in the range from 0.5% to 70%, preferably in the range from 1% to 30% and more preferably in the range from 1% to 25%.

In one embodiment of the present invention, aqueous formulation of the present invention has at 23° C. a dynamic viscosity in the range from 10 to 100 dP·s and preferably in the range from 20 to 30 dPa·s, determined for example by rotary viscometry, for example using a Haake viscometer. The aforementioned viscosity range applies in particular when aqueous formulation of the present invention comprises a print paste.

The present invention further provides for the use of aqueous formulations of the present invention for coloration of substrates. The present invention further provides a process for coloration of substrates by using at least one aqueous formulation of the present invention.

Useful substrates include:

cellulosic materials such as paper, board, card, wood and woodbase, which may each be lacquered or otherwise coated,

metallic materials such as foils, sheets or workpieces composed of aluminum, iron, copper, silver, gold, zinc or alloys thereof, which may each be lacquered or otherwise coated,

silicatic materials such as glass, porcelain and ceramic, which may likewise each be coated,

polymeric materials of any kind such as polystyrene, polyamides, polyethylene or polypropylene, melamine resin, polyacrylates, polyacrylonitrile, polyurethanes, polycarbonates, polyvinyl chloride, polyvinyl alcohols, polyvinyl acetates, polyvinylpyrrolidones and corresponding copolymers including block copolymers, biodegradable polymers and natural polymers such as gelatin, and particularly polyester or polypropylene or mixtures of polyester and polypropylene,

leather—both natural and artificial—in the form of smooth leather, nappa leather or suede leather,

comestibles and cosmetics,

and in particular

textile substrates and fabrics such as wovens, knits, nonwovens and garments composed for example of polyester, modified polyester, blend fabric of more than two materials such as polyester blend fabric and cotton blend fabric, cellulosic materials such as cotton, jute, flax, hemp and ramie, viscose, wool, silk, polyamide, polyamide blend fabric, polyacrylonitrile, polyurethane, polyTHF, triacetate, acetate, polycarbonate, polypropylene, polyvinyl chloride and glass fiber fabric, more preferably of polyester, polypropylene or mixtures of polyester and polypropylene, also polyester blends with, for example, cotton and also polyester microfibers.

The present invention's process for coloration of substrates, hereinafter also referred to as inventive coloration process, can be carried out according to processes known per se. Coating and printing, slop or nip padding, blading and spraying are suitable for example. Printing processes and particularly screen printing processes and blading processes are particularly suitable. When substrates comprise textile, dyeing by textile-dyeing processes such as padding for example is also possible.

The inventive coloration process is carried out by substrate to be colored being treated with at least one inventive aqueous formulation. This can be done for example by uniform treatment or by applying patterns to the substrate to be colored. To apply multicolored patterns, two or more inventive aqueous formulations comprising differently colored pigments (A) can be assembled into sets and treatment can be effected in succession with the various aqueous formulations.

One embodiment of the present invention comprises effecting the inventive coloration process by applying from 50 to 150 g of aqueous formulation/m² of substrate, preferably 70 to 130 g/m², based on 100% coverage. This embodiment is preferred when the inventive coloration process is embodied as a printing process.

In another embodiment of the present invention, the inventive coloration process can be practiced so as to obtain a wet pickup in the range from 20% to 90%. This embodiment is particularly preferred when the inventive coloration process is embodied as a dyeing process. For example, the wet pickup can be selected in the range from 20% to 60% and preferably in the range from 30% to 60% for a polyester substrate and in the range from 40% to 90% and preferably in the range from 50% to 80% for a cotton substrate.

In one embodiment of the inventive coloration process, the treating of substrate with aqueous formulation may be followed by a thermal treatment, in one or more treatment steps. It is possible for example to dry thermally and fix thermally, preference being given to drying at temperatures in the range from 70 to 120° C. for a period in the range from 30 seconds to 30 minutes and/or fixing, if appropriate following the drying operation, at temperatures in the range from 140° C. to 200° C. for a period in the range from 30 seconds to 15 minutes.

The present invention further provides colored substrates, preferably composed of polyester or polyester blends, which have been colored by the inventive coloration process. Colored substrates in accordance with the present invention have excellent general fastnesses such as for example washfastness and rubfastnesses, in particular wet rubfastnesses, and detach no formaldehyde or nonmeasurable amounts of formaldehyde when hot.

The present invention further provides a process for producing inventive aqueous formulations, herein also referred to as inventive production process, said process comprising
(A) at least one pigment,
(B) at least one carbodiimide,
(C) at least one random polyurethane,
(D) optionally at least one polyacrylate comprising no interpolymerized comonomers capable of detaching one equivalent of formaldehyde per mole on exposure to temperatures in the range from 100 to 250° C.,
(E) optionally at least one surfactant and
(F) optionally one or more auxiliary components

being mixed with one another

and if appropriate bulked with water.

The order of addition for constituents (A) to (F) is freely choosable. To use one or more thickening agents as auxiliary component (F), it is preferable to add the thickening agent or agents last or immediately before bulking with water.

The inventive process for producing inventive formulations can be carried out in any desired vessels. To use one or more thickening agents as auxiliary component (F), it is preferable to effect the mixing with the aid of a high speed stirrer, for example an Ultra-Thurrax.

The inventive production process can be carried out with temperatures in the range from 1 to 80° C., preference being given to 5 to 35° C.

The invention is elucidated by working examples.

Preliminary Remark:

The level of free (detached) formaldehyde was in each case determined according to Law 112 and according to AATCC 112 methods (EN ISO 14 184 Parts 1 and 2), DIN EN ISO 14184-1 and DIN EN ISO 14184-2.

I. Preparation of Components of Inventive Aqueous Formulations

1.2 Preparation of Polyacrylate (D.1)

The particle diameter distribution of dispersed or emulsified addition copolymers was determined using a Coulter Counter from Malvern in accordance with ISO 13321. Dynamic viscosities were always determined using a Brookfield viscometer in accordance with DIN 51562-1 to 4.

The following mixtures were prepared:

Mixture I.1.1:

203 g of completely ion-free water

17.9 g of 28% by weight aqueous solution of n-C₁₂H₂₅(OCH₂CH₂)₃OSO₃Na (surfactant (E.1))

245.2 g of n-butylacrylate, 134.8 g of styrene, 20 g of freshly distilled acrylic acid.

Mixture I.1.2: 0.8 g of Na₂S₂O₈ in 80 ml of completely ion-free water

Mixture I.1.3: 0.4 g of HO—CH₂—SO₂Na in 80 ml of completely ion-free water

A 5 l tank equipped with stirrer, nitrogen supply and three metering devices was charged with a suspension comprising 160 ml of completely ion-free water and 9.1 g of polystyrene seed (average diameter 30 nm, 33% by weight suspension in water). Nitrogen was passed through the suspension over a period of one hour. The mixture was then heated to 75° C.

Thereafter, the simultaneous addition of mixture I.1.1, mixture I.1.2 and mixture I.1.3 was commenced. Mixture I.1.1 was added within 3 hours, mixture I.1.2 and mixture I.1.3 were added within 3 hours 15 minutes. The temperature was maintained at 75° C. during the addition.

On completion of the addition the batch was stirred at 75° C. for a further 30 minutes before a solution of 2 g of tert-butyl hydroperoxide (70% by weight in water) in 23 ml of distilled water and a solution of 2 g of acetone disulfite in 23.5 ml of distilled water were simultaneously added over a period of 90 minutes for deodorization.

This was followed by cooling down to room temperature, addition of a mixture of 0.5 g of 20% by weight solution of 1,2-benzisothiazolin-3-one in propylene glycol and 10 ml of distilled water and subsequent stirring for 10 minutes.

Thereafter, a pH of 5 was set with about 4 g of 25% by weight aqueous ammonia.

The dispersions obtainable were subsequently filtered through a 125 μm net. The filtration time was 4 minutes. About 2 g of coagulum were removed as a result.

This gave an aqueous dispersion of polyacrylate (D.1). The solids content was 38.6%, by weight, the dynamic viscosity was 45 mPa·s. Particle diameter distribution: maximum at 156 nm.

1.2 Preparation of Random Polyurethane (C.1)

In a 1 m³ stirred vessel, 81.1 kg of a polyesterol (c2.1) having a molecular weight M_{w} of 800 g/mol, prepared by polycondensation of isophthalic acid, adipic acid and 1,4-dihydroxymethylcyclohexane (isomer mixture) in a molar ratio of 1:1:2, were heated to 110° C. The vessel's internal temperature was raised to 140° C. until polyesterol (c2.1) was present as a clear melt. This was followed by cooling down to 80° C. and addition of 10.5 kg of neopentylglycol (c1.1) and 11 kg of 2,2-bis(hydroxymethyl)propionic acid (d3.1). The system was cooled down to 60° C. and admixed with 82.8 kg of 4,4′-diphenylmethane diisocyanate (MDI) and 185.4 kg of tetrahydrofuran (THF). The reaction was started by addition of 44 g of di-n-butyltin dilaurate. The mixture was stirred at 60° C. until only 1.05% of isocyanate was left to detect titrimetrically. The system was cooled down to 45° C. and then admixed initially with 9.8 kg of diethanolamine, dissolved in 50 kg of THF, and then neutralized with 8.3 kg of triethylamine, dissolved in 8 kg of THF. After addition of 610.3 kg of water, the THF was distilled off to leave an aqueous dispersion of random polyurethane (C.1) having a solids content of 27.5%.

Mₙ: 4800 g/mol, M_{w}: 14 300 g/mol, pH: 8.1,

average particle diameter: 100 nm.

II. Preparation of Inventive Aqueous Formulations

II.1 Preparation of Inventive Print Pastes

The following ingredients were used:

Pigment (A.1): Pigment Preparation

The following were milled together in a Drais Superflow DCP SF 12 stirred ball mill:

2640 g of Pigment Blue 15:3

460 g of n-C₁₈H₃₇O(CH₂CH₂O)₂₅H (surfactant (E.2))

600 g of glycerol

2300 g of distilled water

milling was continued until the pigment particles had an average diameter of 100 nm to give pigment preparation P(A.1).

Carbodiimide (B):

(B.1): carbodiimide based on meta-TMXDI having a titrimetically determined NCO content of 6.7% by weight. This corresponds to about 4.2 carbodiimide groups/molecule.

Surfactants:

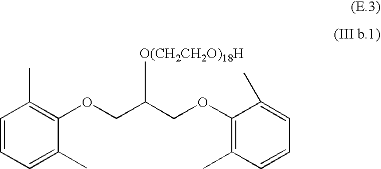

Auxiliary Components:

(F.1) 26% by weight aqueous solution of a random copolymer of acrylic acid (92% by weight), acrylamide (7.6% by weight), methylenebisacrylamide IV.1 (0.4% by weight), quantitatively neutralized with ammonia (25% by weight in water), molecular weight M_{w} of about 150 000 g/mol

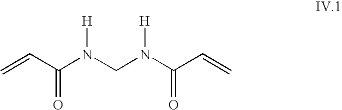

(F.2): HO—(CH₂CH₂O)₃—(CH₂)₃—Si(CH₃)[OSi(CH₃)₃][OSi(CH₃)₂OSi(CH₃)₃] (as 30% by weight solution in propylene glycol)

(F.3): polydimethylsiloxane, Mₙ 5 000 g/mol

(F.4): di-n-nonyl 1,4-cyclohexanedicarboxylate

Inventive print pastes were prepared in accordance with the following general prescription:

The ingredients of table 1 were mixed in a stirred vessel in the following order: 200 ml of water and surfactant (E.3) were introduced as initial charge. When the pH was below 8, a pH of 8.5 was established by addition of 25% by weight aqueous ammonia. Subsequently, carbodiimide (B.1) and, if appropriate, polyacrylate (D.1) of the table were added with stirring. Subsequently, random polyurethane (C.1) as per table (F.1), if appropriate further auxiliary components and finally P(A.1) were added with stirring. The mixture was bulked with water to one liter and subsequently stirred with a high speed stirrer of the Ultra-Turrax type at about 6000 revolutions per minute for 15 minutes.

This gave inventive print pastes as per tables 1 and 2 and, in those cases where one or more of the aforementioned ingredients were omitted, the corresponding comparative print pastes.

TABLE 1
Composition of inventive polyacrylate-containing print pastes
WF. 1 and WF. 2 and of comparative print paste V-WF. 3

| [g] | WF. 1 | WF. 2 | V-WF. 3 |
|---|---|---|---|
| P(A.1) | 20 | 20 | 20 |
| (B.1) | 9 | 9 | 9 |
| (C.1) (corresponds to | 50 (13.75) | 100 (27.5) | — |
| g of solids) | | | |
| (D.1) | 100 | 100 | 100 |
| (E.3) | 5 | 5 | 5 |
| (F.1) | 40 | 40 | 40 |
| (F.2) | 1 | 1 | 1 |
| NH₃ | 1 | 1 | 1 |
| Water | 774 | 724 | 824 |

Note:
all reported amounts gross.

TABLE 2
Composition of inventive polyacrylate-free print pastes WF.4 to WF.14
and of comparative print pastes V-WF.15 and V-WF.16

| | WF.4 | WF.5 | WF.6 | WF.7 | WF.8 | WF.9 | WF.10 |
|---|---|---|---|---|---|---|---|
| P(A.1) | 20 | 20 | 20 | 20 | 20 | 20 | 20 |
| (B.1) | 9 | 9 | 9 | 9 | 9 | 9 | 9 |
| (C.1) | 20 | 40 | 60 | 80 | 100 | 120 | 150 |
| (D.1) | — | — | — | — | — | — | — |
| (E.3) | 5 | 5 | 5 | 5 | 5 | 5 | 5 |
| (F.1) | 40 | 40 | 40 | 40 | 40 | 40 | 40 |
| (F.2) | 1 | 1 | 1 | 1 | 1 | 1 | 1 |
| NH₃ | 1 | 1 | 1 | 1 | 1 | 1 | 1 |
| Water | Add | Add | Add | Add | Add | Add | Add |
| | 100 | 100 | 100 | 100 | 100 | 100 | 100 |

| | WF.11 | WF.12 | WF.13 | WF.14 | V-WF.15 | V-WF.16 |
|---|---|---|---|---|---|---|
| P(A.1) | 20 | 20 | 20 | 20 | 20 | 20 |
| (B.1) | 9 | 9 | 9 | 9 | 9 | 9 |
| (C.1) | 20 | 40 | 60 | 80 | — | — |
| (D.1) | | | | | 100 | 100 |
| (E.3) | 5 | 5 | 5 | 5 | 5 | 5 |
| (F.1) | 40 | 40 | 40 | 40 | 40 | 40 |
| (F.2) | 1 | 1 | 1 | 1 | 1 | 1 |
| (F.3) | 4 | 4 | 4 | — | 4 | — |
| (F.4) | 4 | 4 | 4 | — | 4 | — |
| NH₃ | 1 | 1 | 1 | 1 | 1 | 1 |
| Water | Add | Add | Add | Add | Add | Add |
| | 100 | 100 | 100 | 100 | 100 | 100 |

All data reported in g/100 g of print paste
NH₃ designates the amount of a 25% by weight aqueous solution

II.2 Production of Inventive Dyeing Liquors and of a Comparative Dyeing Liquor

Components used (unless already characterized under (II.1)):

(D.2): aqueous dispersion (solids content: 48.4%) of a random copolymer composed of 46.3% of 2-ethylhexyl acrylate, 28.7% of styrene, 10% of methyl methacrylate, 10% of acrylonitrile, 5% of acrylic acid. Average particle diameter: 269 nm, pH: 6.8.

(D.3): random copolymer of ethylene and acrylic acid, comonomer ratio 85:15 (parts by weight), neutralized with NH₃, pH: 9, as 25% by weight dispersion, efflux time in DIN 5 cup (DIN53211): 72 s.

(E.4): C13/C15 oxo process alcohol mixture ethoxylated with 5 mol of ethylene oxide

(E,5): 2-ethylhexyl alcohol ethoxylated with 15 mol of ethylene oxide and then propoxylated with 3 mol of propylene oxide.

(F.5): random copolymer formed from acrylic acid and acrylamide, comonomer ratio 70:30 (parts by weight), as 25% by weight dispersion, dynamic viscosity 5 000 mPa·s at 20° C.

The components of table 3 were stirred together. The dyeing liquors for examples 14 to 21 were produced by stirring together the recited components using a high-speed stirrer.

TABLE 3
Production of inventive dyeing liquors WF.18 to WF.24 and
of comparative dyeing liquor V-WF.17

| | WF.17 | WF.18 | WF.19 | WF.20 | WF.21 | WF.22 | WF.23 | WF.24 |
|---|---|---|---|---|---|---|---|---|
| P(A.1). | 20 | 20 | 20 | 20 | 20 | 20 | 20 | 20 |
| (B.1) | 12 | 12 | 12 | 10 | 12 | 18 | 12 | 20 |
| (C.1) | 60 | 60 | 60 | 60 | 60 | 60 | 60 | 60 |
| (D.1) | | | | | | | 50 | |
| (D.2) | | | 100 | | | | | |
| (D.3) | 100 | 100 | | | | | | |
| (F.5) | 20 | 20 | 20 | 20 | 20 | 20 | 20 | 20 |
| (E.4) | 5 | 5 | 5 | 5 | 5 | 5 | 5 | 5 |
| (E.5) | 3 | 3 | 3 | 3 | 3 | 3 | 3 | 3 |
| (F.1) | 5 | 5 | 5 | 5 | 5 | 5 | 5 | 5 |
| Perapret PU | 100 | | | 50 | 100 | 150 | | 100 |

All amounts reported in g per 1000 g of dye liquor. They are all gross.

III. Coloration of Textile

III.1 Printing of Polyester Fabric with Inventive Aqueous Print Pastes and with the Comparative Print Paste

White polyester fabric (basis weight 120 g/m²) was separately printed with inventive print paste WF.1, inventive print paste WF.2 and comparative print paste V-WF.3 using a squeegee (diameter 6 mm) moving over a stripe template (E 55 screen gauze), magnet pull level 6.

The fabrics were dried in a drying cabinet at 80° C. for 5 min to a residual moisture content of about 10% and subsequently fixed at 150° C. for 5 minutes in a hot air cabinet to obtain inventive colored polyester PES.1, inventive colored polyester PES.2 and comparative polyester V-PES.3.

Inventive colored polyester PES.1 and inventive colored polyester PES.2 had no measurable formaldehyde emissions.

The washfastnesses of table 4 were found.

TABLE 4
Washfastnesses of colored textiles PES. 1, PES. 2 and V-PES. 3

| | PES. 1 | PES. 2 | V-PES. 3 |
|---|---|---|---|
| Wet rubfastness | 3-4 | 3-4 | 2 |

Wet rubfastness was determined in accordance with EN ISO 105 003. Test fabric lightening in color was assessed.

White polyester microfiber fabric having a fabric weight of 95 g/m² was printed with one of the inventive print pastes WF.4 to WF.14 or with one of the comparative print pastes V-WF.15 and V-WF.16 using a squeegee (diameter 6 mm) moving over a stripe template (E 55 screen gauze), magnet pull level 6.

The fabrics were dried in a drying cabinet at 80° C. for 5 min to a residual moisture content of about 10% and subsequently fixed at 150° C. for 5 minutes in a hot air cabinet to obtain inventive colored polyester PES.4 to PES.14 and comparative polyesters V-PES.15 to V-PES.16.

Inventive colored polyester PES.4 to PES.14 had no measurable formaldehyde emissions.

The prints were assessed by subjecting each to the DIN EN ISO 105-007 boil scrub wash before and after the thermal treatment (Textiles—Color-Fastness Tests Part 007: Colorfastness to Wet Scrubbing of Pigment-Printed Textiles (ISO 105-007:1999); German Version EN ISO 105-007:2001).

The fastnesses of table 5 were found.

TABLE 5
Fastnesses of PES. 4 to PES. 14 polyester microfiber
fabrics printed according to the invention and of
comparative textiles V-PES. 15 and V-PES. 16

| | Boil scrub wash | Rubfastness dry | Rubfastness wet |
|---|---|---|---|
| PES. 4 | 3 | 3-4 | 3 |
| PES. 5 | 4 | 4 | 3-4 |
| PES. 6 | 4-5 | 4-5 | 4 |
| PES. 7 | 4-5 | 4-5 | 4 |
| PES. 8 | 5 | 4 | 4 |
| PES. 9 | 5 | 4-5 | 4 |
| PES. 10 | 5 | 4-5 | 4 |
| PES. 11 | 3 | 3 | 3 |
| PES. 12 | 4 | 4-5 | 4 |
| PES. 13 | 4-5 | 4-5 | 4 |
| PES. 14 | 4-5 | 4-5 | 4 |
| V-PES. 15 | 2-3 | 3 | 2-3 |
| V-PES. 16 | 2-3 | 3-4 | 3 |

III.2 Dyeing of Polypropylene with Inventive and Comparative Dyeing Liquors

Undyed 365 g/m² polypropylene belts 5 cm in width were used as starting material. Application was by means of a pad-mangle. The dyed material was dried in a drying cabinet at 110° C. for 90 seconds to a residual moisture content of about 10% and subsequently fixed at 130° C. in a hot air cabinet for 90 seconds. This was followed by calendering with a pad-mangle using a contact pressure of 5 bar and a pull-through speed of 1 m/min.

Polypropylene belts PP.18 to PP.24 dyed according to the present invention and polypropylene belt PP.17 as per table 6 were obtained.

TABLE 6
Properties of inventive dyed polypropylene belts PP.18 to PP.24 and
comparative polypropylene belt PP.17, each have satisfactory properties

| | PP.17 | PP.18 | PP.19 | PP.20 | PP.21 | PP.22 | PP.23 | PP.24 |
|---|---|---|---|---|---|---|---|---|
| hue | | = | = | = | = | = | = | = |
| depth of | | =+ | + | + | + | + | + | + |
| shade | | | | | | | | |
| marking | | + | + | + | + | + | + | + |
| stress- | | + | + | + | + | + | + | + |
| whitening | | | | | | | | |
| hand | | =+ | =+ | + | + | + | + | + |
| rubfastness | 3-4 | 4 | 4-5 | 4-5 | 4 | 4 | 4 | 4 |
| dry | | | | | | | | |

Hue, depth of shade, marking and scratching, stress-whitening and hand were each compared with V-PP.17. =: no difference detectable, +: significant difference detectable with the naked eye, =+: slight improvement detectable with the naked eye.

1-13. (canceled)

14. An aqueous formulation comprising
(A) at least one pigment,
(B) at least one carbodiimide,
(C) at least one random polyurethane, and
(D) at least one polyacrylate comprising no interpolymerized co-monomers capable of detaching one equivalent of formaldehyde per mole on exposure to temperatures in the range from 100 to 250° C.

15. The aqueous formulation according to claim 14, wherein the random polyurethane (C) comprises a polyurethane comprising (c1) an interpolymerized aliphatic diol having 2 to 10 carbon atoms per molecule.

16. The aqueous formulation according to claim 14, wherein the random polyurethane (C) comprises a polyurethane comprising (c2) an interpolymerized polyesterpolyol.

17. The aqueous formulation according to claim 14, wherein the carbodiimide (B) comprises a polymeric carbodiimide.

18. The aqueous formulation according to claim 14, wherein the random polyurethane (C) comprises a polyurethane comprising (c3) an interpolymerized compound having at least one carboxylic acid group or at least one sulfonic acid group per molecule.

19. The aqueous formulation according to claim 14, further comprising (E) at least one surfactant.

20. The aqueous formulation according to claim 14, when selected from aqueous print pastes, dyeing liquors, coating pastes and pastes for fibrous nonwoven web consolidation.

21. A process for coloration of substrates, comprising coloring at least one substrate with at least one aqueous formulation according to claim 14.

22. The process according to claim 21, wherein the substrate comprises polyester or polypropylene or a mixture thereof.

23. The process according to claim 21, wherein the at least one substrate is a textile substrate.

24. A colored substrate obtained by a process according to claim 21.

25. A process for preparing the aqueous formulation according to claim 14, which comprises mixing
(A) at least one pigment,
(B) at least one carbodiimide,
(C) at least one random polyurethane,
(D) optionally at least one polyacrylate comprising no interpolymerized co-monomers capable of detaching one equivalent of formaldehyde per mole on exposure to temperatures in the range from 100 to 250° C.

26. The process of claim 25, further comprising mixing at least one surfactant.
